(19) United States
(12) Patent Application Publication
(10) Pub. No.: US 2019/0266586 A1
(43) Pub. Date: Aug. 29, 2019

(54) PAYMENT STATUS ALERT NOTIFICATION SYSTEM

(71) Applicant: SoftPoint LLC, Scottsdale, AZ (US)

(72) Inventor: Christian Rivadalla, Scottsdale, AZ (US)

(73) Assignee: SoftPoint LLC, Scottsdale, AZ (US)

(21) Appl. No.: 15/904,361

(22) Filed: Feb. 24, 2018

(51) Int. Cl. G06Q 20/22

(52) U.S. Cl. CPC G06Q 20/22

(57) ABSTRACT

The invention provides a system or method which allows a merchant to get payment status once the payment is done by a customer on any smart payment terminal where the payment process system is installed. Customers at a merchant can pay for their bill using payment terminals with credit cards or other forms of payments which can happen with or without involving the employee. Customers pay their bill using the payment terminal and once the payment is executed, a status of the payment is detected by the agent installed in the payment terminal which sends a message to a server. The message is then broadcast to the merchant using different notification protocols. Using the present invention, the payment can be processed completely external to the point of sales system. The merchant may use this system to enhance the operational flow of the business and help with the handling of multiple customers at one time. The present invention provides a fully integrated hospitality management solution for restaurants, retail, spa, ticketing, medical and other different markets. For example: in restaurants or at any other establishment; the customer is provided with a payment terminal. The employee can place an order and the customer can pay using said payment terminal. Once the payment status is detected by the agent, it will send a message to the server which then notifies the merchant and employee about the order that was placed.

### TECHNOLOGICAL FIELD

The technology relates to the general field of smart payment terminals, smart payment terminal software, and has certain specific applications to notifying an end merchant or employee about the status of the payment performed on the smart payment terminal through the use of a notification that can be sent to a server and broadcast in many ways.

### BACKGROUND

The number of people who pay with multiple forms of non-cash methods has increased recently. The burden increases the work load on the employees which should serve each customer efficiently. Employees need to take orders from the customers and serve them. Then in the end, employees need to present the bill and wait at the customer's place to complete the payment process. This takes up valuable time the employee could have used to serve other customers without having to wait for each customer to complete the payment process.

Moreover, many merchants do not have the budget to have more employees to handle large number of customers. Therefore, it is required to save the time of the employees and make them more efficient to serve and look after other customers.

Thus, there is a need to address these competing interests, whereby the customers are presented with a bill along with a payment terminal and the employee is no longer required to be present to witness completion of the payment process. Instead, a notification about the status of the payment will be sent to the employee regardless of whether the payment is approved or declined after a transaction has been completed, which prevents employees from undue burden, and adversely impacts the merchant's efficiency.

U.S. Pat. No. 7,457,767 Rodney, et al. provides a system comprising of a payment unit physically located at the table which can display a total amount to be paid. A screen displaying the total amount for the plurality of patrons, credit card reader is also available on the payment unit with a numeric input pad. Rodney, et al. provides a functionality for computing total amount owed by the plurality of patrons together with a payment unit.

U.S. Pat. No. 5,933,812 Meyer, et al. provides a portable transaction terminal with a data entry keypad at the guest table in any eating and drinking establishment. The portable transaction terminal is nothing but a payment device commonly found and available at many commercial places and establishments. What Rodney, et al. and Meyer, et al. don't disclose is an ability and/or functionality of detecting the status of the payment after completion and sending the status to a server which can be broadcast further to notifying the merchant owner or the employee.

### SUMMARY OF THE INVENTION

It is one of the aims of the present invention to provide an integrated hospitality management system for Restaurants, Hotels, Retailers, Spas, Ticketing, Medical and other market types. It provides applications and a solution to enhance operations and back office management functions, ultimately providing your customers with a better overall experience.

The system of the present invention provides the ability for any smart payment terminal to report the status of a customer's payment using a notification which can be provided via, SMS, email, API call or various notification protocol. The receiver can see the text message, check email, get a notification on a smartphone or smartwatch or visit a link in a browser to view the status of the payment after the notification is provided.

DataPoint Notifier which is the commercial name of the invention is designed to work with SoftPoint's DataPoint Ultimate Payment Experience solution. DataPoint is an integrated tool that allows a merchant on various point of sale systems to take secure PCI compliant transactions on a smart payment terminal. The invention is used to be able to alert any end user of the status of a payment. For example, you can drop the smart payment terminal at a customer's table in a restaurant and leave it with the customer, once the customer makes a payment the terminal sends the message notification to an endpoint such as a smartwatch and the end user is alerted of the status of the payment.

The following example will clarify the method and process of the present invention. A customer or a group of customers dining at a restaurant, where the customer and group of customers has placed an order. The bill for the order is fed into the payment terminal and presented to the customer by an employee. After that the employee can leave the table. The customer pays the bill using a credit/debit card or any other form of payment. The payment process is detected by the agent installed in the payment terminal and processed. After the payment is completed, the agent notifier sends a notification to the merchant or employee about the payment. Notification can be in the form of an SMS, a link in the web browser, email, or notification on the smartwatch or smartphone of the employee. The present invention reduces the burden on the employee by allowing them to leave the customer after the payment terminal is presented to them. Other embodiments of the present invention have been described in the detailed description that follows below:

### Definitions

A. Smart Payment Terminal: Where we can pay using credit cards or other payment methods.
B. Watchpoint App: Inventors product which is to be installed in the smart device to receive and display notifications.
C. Smart Watch: One of the available endpoints a notification can be displayed on after the payment is done.
D. Merchant: A person or company selling, trading, or performing any type of commerce.
E. Employee: A person working for a merchant and responsible for activities setup our for the merchant.

The following detailed description of the invention references the accompanying drawings that illustrate specific embodiments in which the invention can be practiced. The embodiments are intended to describe aspects of the invention in sufficient detail to enable those skilled in the art to practice the invention. Other embodiments can be utilized, and changes can be made without departing from the scope of the current invention. The following detailed description is, therefore, not to be taken in a limiting sense. The scope of the current invention is defined only by the appended claims, along with the full scope of equivalents to which such claims are entitled.

### DESCRIPTION OF THE DRAWINGS

FIG. 1 illustrates the architecture of the payment status alert notification system of the present invention.

FIG. 2 illustrates a flow diagram implementing the steps in accordance with the first embodiment of the present invention.

FIG. 3 illustrates a network for implementing the present invention according to another embodiment of the present invention.

FIG. 4 illustrates a network for implementing the present invention according to another embodiment of the present invention.

FIG. 5 illustrates a block diagram for implementing the present invention as another embodiment of the present invention.

FIG. 6 illustrates a system installed at service kiosks to process payment independently of a point of sale terminal as another embodiment of the present invention.

### DETAILED DESCRIPTION OF THE INVENTION

The system of the present invention provides an easy way for a merchant to get notified about the status of a payment done through a smart payment terminal. According to one of the embodiments of the present invention, the employee is no longer required to be present while the customer is completing a payment. The employee can drop or leave the smart payment terminal with the customer with the total bill to be paid. The customer can thereafter operate the payment terminal to complete the payment transaction. Once a transaction is completed, the merchant will be notified. The method of notification can include displaying a message via SMS, email, Call on computer via browser, etc. It can also be done via a notification to a smart watch integrated with the system of present invention.

An application referred to as an agent is added to the payment terminal. That agent sees the result of a payment. It then takes those results and notifies based on the preset method defined to notify. The endpoint receiving the message then displays it. We have an application in a smartwatch that listens to the notification and displays them.

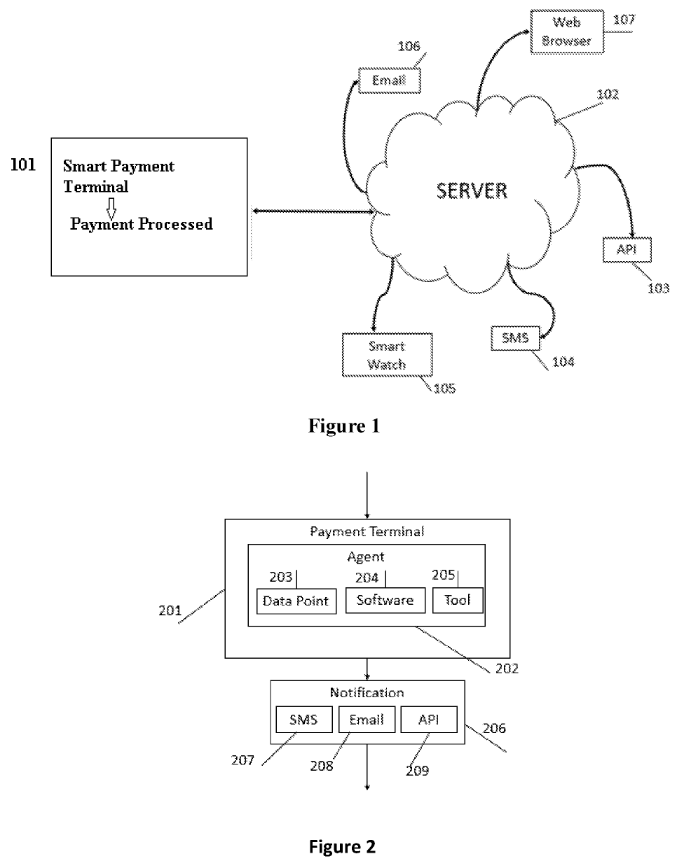

Referring to FIG. 1, a smart payment terminal attached with an agent installed 101 is given to a user for transacting a payment at a restaurant, spa, ticket counter, train, service kiosk etc. The customer uses the smart payment terminal to process his payment using any type of payment type, including but not limited to, credit or debit cards. The payment terminal may provide an option to user on type of payment, amount to pay, card details, type of receipt if required etc. It may also ask the user either to pay as a guest or to sign in and becoming a member. By opting this feature, the smart terminal will permanently keep the credentials of the customer and set the default setting of the payment and receipt type for future payments. The agent attached within the smart payment card detects the status of the payment upon its completion and sends the generated status to the server 102. The server may broadcast the status of the payment to an end user or the merchant via one or more of the method described by 103, 104, 105, 106, 107. This way the payment can be made and processed external to the cash and sale counter without disturbing the business operations.

Referring to FIG. 2, a customer is supposed to make a transaction using a payment terminal 201 and after the payment has been made, an agent 202 which is attached or linked within the payment terminal 201 detects if the payment made is completed (fully or partially) and/or failed using at least one of the pre-installed instructions and integrated tools including but not limited to DataPoint 203, a Software 204, detection tools 205, and notifying or reflecting the status of the transaction to an end point through notification protocols including but not limited to SMS 207, Email 208, and API 209.

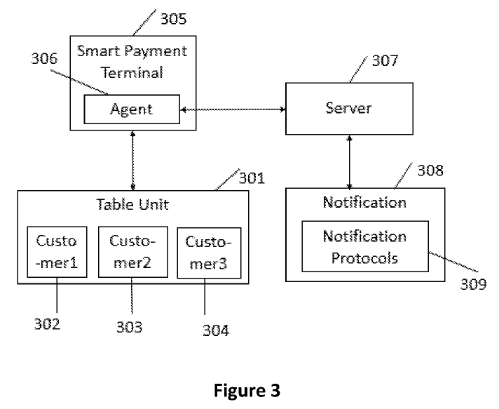

Referring to FIG. 3, a method and system to update table status and to notify the server when a customer order is ready is provided as another embodiment of the present invention. A table unit 301 is occupied by a customer 302 or a plurality of customers (302, 303, 304) in an eating and/or drinking establishment. A smart payment terminal 305 is provided on the table unit 301 for the customers (302, 303, 304) to pay their bills using a payment card. The payment card includes but is not limited to a credit or debit card. An agent 306 is attached to the payment terminal 305 consisting of integrated tools and/or software which can detect the status of the payment made at the smart payment terminal 305. The agent 306 is connected to a server 307 with which it can communicate. The server could be an inter or intra network of the establishment and/or a cloud-based system. The server 307 can broadcast the status received from the agent 306 through the notification 308 using various notification protocols 309 to make aware or notify the employee or merchant of the establishment.

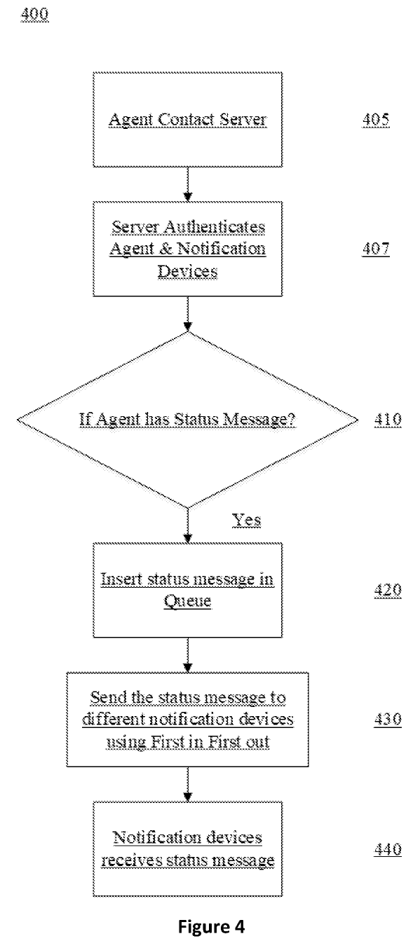

With reference now to FIG. 4, a flowchart of a process according to the method of present invention to send a payment completion message to the server and then broadcast it is using different notification methods is shown in accordance with one embodiment of the present invention. It is appreciated that the steps of flowchart 400 are exemplary and that some steps may be skipped, and other steps may be added depending on the plurality of possible contacting and re-transmitting protocols which may be used by the plethora of possible client devices. The present steps (e.g., steps 405 through 450) are meant to illustrate one of the plurality of possible ways in which a merchant may receive the notification broadcast.

With reference now to step 405 of FIG. 4, an agent integrated with the payment terminal contacts a broadcast server to send the payment status notification for broadcast. As described herein, the agent may contact the broadcast server via a network connection.

With reference now to step 407 of FIG. 4, once the agent contacts the broadcast server, the broadcast server may authenticate the agent and different notification devices to ensure that the agent and the notification devices have permission to access the server for broadcasting the message to a user using different notification methods. For example, if the status is a payment completion notification, the merchant and employee involved may get a notification via SMS, API, Email, smart watch, smart phone, or browser which are authorized to receive the broadcast. Therefore, if an unauthorized device contacted the broadcast server, or any of the other devices for receiving the broadcast, the unauthorized device would be denied access and could not receive the status broadcast message or any re-transmissions of the broadcast. In one embodiment, the authentication may be based on a pre-determined status.

With reference now to step 410 of FIG. 4, after authenticating the agent and notification devices, the broadcast server may check to see periodically if the agent has sent a status message and the server is alerted after a status message is sent to the server.

With reference now to step 420 of FIG. 4, if the broadcast server has received the status message over the network, then the broadcast server puts the message in a queue and will initiate a stream to deliver the status message broadcast to a user or owner using a first notification protocol.

However, with reference now to step 430 of FIG. 4, if the broadcast server is already broadcasting the status message over the network, then in one embodiment, the broadcast server may maintain a queue of all status message it receives during the transmission period and transmit messages in a first in first out fashion i.e. the message which came first to the server will be broadcast to different devices first followed by subsequent messages. Therefore, the broadcast server may provide the next status message to the user via broadcast after the first broadcast transmission has completed. For example, if the broadcast server is broadcasting the status message notification over the network, then in one embodiment, the broadcast server may broadcast the second status message to the authorized notification methods after completion of the first broadcast which is already being received by the authorized notification methods.

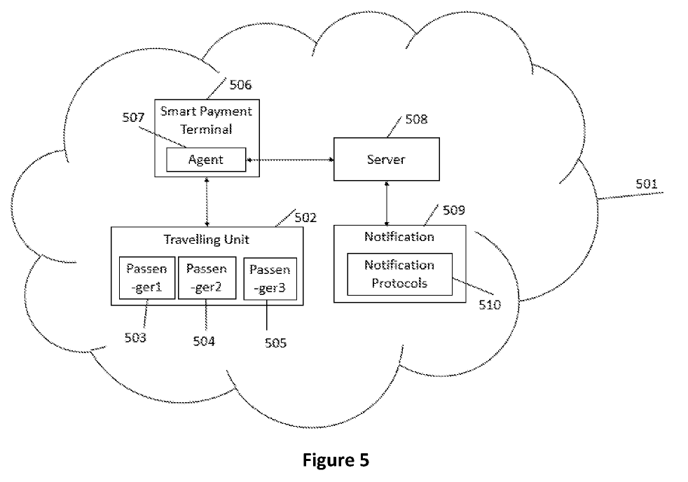

Referring to FIG. 5, the implementation of the present invention in any travelling platform or medium 501 has been described where the medium of travelling includes but is not limited to a train, bus, or airplane. The travelling units 502 including seats or berths have been occupied by a passenger or a plurality of passengers (503, 504, 505). The passengers can order their food or drinks online in advance or at any spot during the journey. The passengers will be provided the smart payment terminals 506 at their individual travelling units 502 which they can use to pay their expenses in the form of any of the payment cards without having the presence of the selling employee. An agent 507 is attached or installed to the smart payment terminal 506 which detects the status of the payment upon completion of the transaction. The agent 507 can communicate or exchange information to and from a server 508 and thereby, sends the status of the payment to the server 508 which broadcasts the status of the payment done at the terminal 506 and generates a notification 508 to identify to the merchant or the payment receiving site by using some of the notification protocols 509.

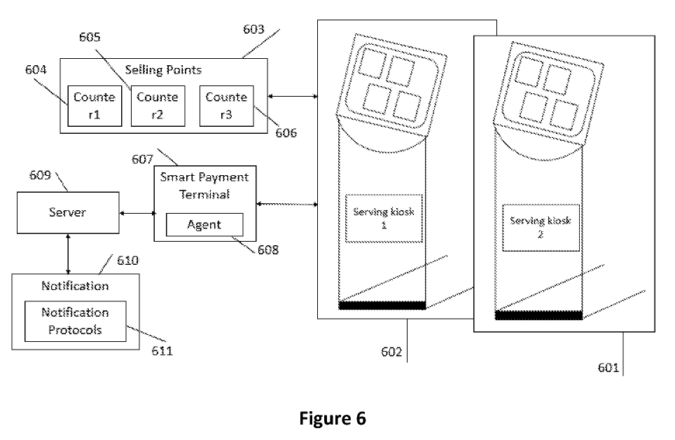

Referring to FIG. 6, using the present invention the payments can be processed independently of the point of sale terminal. The presented service kiosks 601 and 602 are available in any eating and drinking establishments, conventions, theaters, hotels, airplanes, train platforms etc. The customer or customers may place their orders using the kiosks 601 or 602 and payment can be made and processed independent to the point of sales terminal 603 or points (604, 605, 606). A Smart Payment Terminal 607 is installed or linked to the services kiosk in operations which the customers can use to transact the final payment. An agent 608 is attached or installed into the smart payment terminal which can detect the status of the payment upon completion and send the status over s server 609 which can then broadcast the payment status by generating a notification 610 and notifying the establishment employees or owner using some notification protocols 611. Hence, by allowing and processing the payment externally to the point of sales terminal, the system can enhance the operational flow of the business.

Some use cases and features listed above may not make sense in practical ways, but they are being provided to enable some of the applications in the future. While the foregoing is directed to embodiments of the present invention, other and further embodiments of the invention may be devised without departing from the basic scope thereof, and the scope thereof is determined by the claims that follow.

The disclosed embodiments are illustrative, not restrictive. While specific configurations of the present invention have been described, it is understood that the present invention can be applied to a wide variety of payment methods. There are many alternative ways of implementing the invention. Although the present invention and its advantages have been described in detail, it should be understood that various changes, substitutions and alterations can be made herein without departing from the spirit and scope of the invention as defined by the appended claims.

1. A system for providing notification to a first user when a payment is received from a second user comprising:
providing a payment terminal to the second user;
an agent associated with the payment terminal;
allowing the second user to complete the payment process using the payment terminal;
detection by the agent about status of the payment made;
sending a payment completion message to a server by the agent;
broadcasting a notification to the first user about the status of the payment by the server;

2. The second user as recited in claim 1, wherein the second user is a customer of the first user.

3. The agent as recited in claim 1, wherein the agent is a hardware attached to the payment terminal.

4. The agent as recited in claim 1, wherein the agent is a software and/or an application program.

5. The status as recited in claim 1, wherein the status of the payment includes completion and/or failure of the payment made.

6. The notification as recited in claim 1, wherein the notification is provided using at least an SMS, Email, smartphone, smartwatch, tablet, call, browser link, and/or a notification protocol.

7. A method for providing notification to a first user when a payment is received from a second user comprising the steps of:
providing a payment terminal to the second user;
an agent associated with the payment terminal;
allowing the second user to complete the payment process using the payment terminal;
detecting the status of the payment made;
sending a payment status message to a server by the agent;
broadcasting notification to the first user about the status of the payment by the server;

8. The second user as recited in claim 7, wherein the second user is a customer of the first user.

9. The agent of claim 7, wherein the agent is a hardware attached to the payment terminal.

10. The agent of claim 7, wherein the agent is a software and/or an application program.

11. The status as recited in claim 7, wherein the status of the payment includes completion and/or failure of the payment made.

12. The notification as recited in claim 7, wherein the notification is provided using at least an SMS, Email, smartwatch, smartphone, tablet call, browser link, and/or a notification protocol.
